(19) United States
(12) Patent Application Publication
(10) Pub. No.: US 2003/0120797 A1
(43) Pub. Date: Jun. 26, 2003

(54) Apparatus and method for reassembling fragments of a data packet

(75) Inventors: Olivier Brodeur, Hull (CA); David Bush, Ottawa (CA); Mark W. Vanheule, Ottawa (CA); Daniel B. Stewart, Perth (CA)

Correspondence Address: SMART & BIGGAR, P.O. BOX 2999, STATION D, 55 METCALFE STREET, SUITE 900, OTTAWA, ON, K1P5Y6, CA

(73) Assignee: AR Card

(21) Appl. No.: 10/025,616

(22) Filed: Dec. 26, 2001

(51) Int. Cl. G06F 15/16

(52) U.S. Cl. 709/236

(57) ABSTRACT

Apparatus and method to reassemble fragments of data packets are provided which minimized unaligned memory accesses. The second and subsequent fragments have an end of fragment (EOF) portion of the payload moved to before a start of fragment (SOF) portion such that only one unaligned memory access per fragment is required.

### FIELD OF THE INVENTION

This invention relates to the fragmentation and reassembly of variable length data-packets that must be fragmented so that they may fit into fixed-size cells used by a transport layer.

### BACKGROUND OF THE INVENTION

In data packet communication systems where packets need to be fragmented and reassembled in order to be sent through a fixed-size cell transport layer, there could be a memory alignment problem, within the computational unit receiving the data. The problem exists if the cell size is not compatible with the addressing granularity of the memory that is used to store the data at the receiving computational unit (receiver). During reassembly of the packet the problem is caused by having to store the beginning of a number of fragments in memory addresses that are not at regular offsets, defined by the addressing granularity of that system. Thus, to store and reassemble the fragments into packets a number of undesirable unaligned memory-access operations must be carried out.

If an explicit scheme for fragmentation, at the origin of the packet, is not employed then the fragments must be carefully aligned and placed, to reassemble the packet, at the destination of the data. The number of hardware operations that must be carried out to reassemble any given packet can be used to measure the efficiency of reassembling the packet. Unaligned memory-accesses are undesirable because they require significantly more operations than aligned memory-accesses. Thus, a reassembly technique that minimizes the number of unaligned memory accesses is a desirable feature in systems that use fixed-size cells to transport variable length data-packets between computational units.

The common solution to this problem is to separate the packet into fragments that are smaller than what the fixed-size cell would accommodate such that the length of each fragment is compatible with the addressing granularity of the receiving computational unit. In other words, the fragment size is constrained to be less than or equal to that of the cell size and also evenly divisible by the size of smallest addressable memory unit a within the receiver. The result is positive in that all memory accesses within the receiver will be aligned memory accesses. However, there are two problems with this technique. The first is that there is a requirement for the transport mechanism to have some knowledge of the addressing granularity employed by each computational unit (i.e. potential receiver) in the system. And the second is that this solution has the inherent disadvantage of not completely utilizing the available bandwidth of the transport layer, since the fixed-size cells will not be completely full of meaningful data. Because the fragments will be smaller than the payload of a cell, the remaining empty portion of the payload, within any given cell, must be filled with meaningless data symbols for the transport mechanism to work as designed.

### SUMMARY OF THE INVENTION

The present invention provides a method for manipulating fragments of a packet such that the number of unaligned memory accesses, within a computational unit (such as a receiver) are kept to a minimum.

By rotating the symbols of second and subsequent fragments, of the packet, to the right i.e. by moving an EOF (end of fragment) portion of the payload of a cell to before the SOF (start of fragment) portion of the payload, by some number of symbols this problem can be resolved such that at most one unaligned memory access is required per fragment.

The number of symbols (or bytes) by which the payload is rotated is a function of the sequence number of the cell, the cell size and the size of the smallest addressable memory unit.

In some embodiments the size of the EOF portion rotated expressed in symbols is given by

Symbol_rotation=(SN*CS)mod(MUS)

where SN is a sequence number for the fragment, CS is a size of a fixed-size cell used to carry the fragment, in terms of symbols, and MUS is a size of a single memory location in a memory to which the fragments are to be transferred, also in terms of symbols.

In some embodiments the method further includes transferring the first fragment and each other fragment thus rotated in sequence to an input buffer; after any fragment is transferred to the input buffer, transferring the fragment to a packet buffer with no unaligned memory accesses for the first fragment, and a maximum of one unaligned memory access for each other fragment.

In some embodiments after a fragment is transferred to the input buffer, the fragment is stored in the input buffer in a first memory location, a plurality of intermediate memory locations and a last memory location. Transferring each fragment to the packet buffer comprises: for the first fragment, transferring the entire fragment to the packet buffer including a last portion of the fragment in a last written-to memory location in the packet buffer, the last portion being the terminating portion for the first fragment; for second and subsequent fragments: a) in an unaligned memory access, combining the portion of the preceding fragment in the last written-to memory location for the preceding fragment in the packet buffer with data from the first memory location and writing it to the last written-to memory location for the preceding fragment; b) writing intermediate memory locations from the input buffer to the packet buffer using aligned memory accesses; c) combining contents of the last memory location in the input buffer with the EOF portion for the fragment and writing to a last written-to memory location in the packet buffer for the fragment, the combination of the last memory location with the EOF portion for the fragment being the terminating portion for the fragment.

Another broad aspect of the invention provides an apparatus for use in reassembling fragments of a data packet in memory having a smallest addressable memory unit, the apparatus comprising means for rotating an EOF (end of fragment) portion of a payload of each fragment to before an SOF (start of fragment) portion of the payload of the fragment and means for determining the size of each EOF portion as a function of a sequence number of the fragment, the fragment size and the size of the smallest addressable unit.

Another broad aspect provides an apparatus comprising: a packet rotator adapted to process fragments of a data packet comprising, for second and subsequent fragments of the data packet, by rotating an EOF (end of fragment) portion of a payload of each fragment to before a SOF (start of fragment) portion of the payload of the fragment, the size of the EOF portion being equal to a size of a terminating portion of a respective preceding fragment.

In some embodiments, the apparatus further includes an input buffer; a packet buffer having a smallest addressable memory unit; the fragment rotator being adapted to transfer the first fragment and each other fragment thus rotated in sequence to the input buffer; a buffer loader adapted to transfer contents of the input buffer to the packet buffer, by after any fragment is transferred to the input buffer, transferring the fragment to the packet buffer with no unaligned memory accesses for the first fragment, and a maximum of one unaligned memory access for each other fragment.

For embodiments including transport, the available bandwidth of the transport layer is used as efficiently as possible given all other constraints, while significantly reducing the number of unaligned memory accesses within the computational unit. The additional benefit is that the transport layer no longer requires knowledge of the addressing granularity of the memory used by any of the computational units in the system.

A further benefit to this method is that it can be applied either before transmission or after reception of the fragments. It would be preferable, however, to implement the apparatus of this invention close to or as part of a receiving unit so that a transmitting unit is not required to store knowledge about anything related to any number of the receiving units used in a larger system. In this manner, only the knowledge of the packet size must be determined and that information is typically readily available within the overhead of the packet.

The present invention provides a method for manipulating fragments of a packet, the fragment being the same size as the available payload within a fixed-size cell, such that the number of unaligned memory accesses within the computational unit is at most one. No more than one (or possibly zero) unaligned memory access per fragment per packet is required after employing the method of this invention. Furthermore this invention also provides an apparatus adapted to implement this method.

As previously indicated, the system being considered for this invention depicts situations where information, stored within variable-length packets, is shared between computational units meant to use the information. The information is stored within the packets using symbols, and, with respect to the embodiment of this invention, those symbols are eight-bit binary words known as bytes. However, the composition of the symbols to be used with the method presented is not of any consequence as the method will work on any type of information bearing symbol used to store data. This is a result of the method operating on the sequence of the symbols, not the contents of the symbols.

### BRIEF DESCRIPTION OF THE DRAWINGS

The invention will now be described in greater detail with reference to the accompanying diagrams, in which:

FIG. 1 is a simplified schematic diagram of a packet communication system provided by an embodiment of the invention;

FIG. 2 illustrates an example of the fragmentation of a large, variable-length packet into cells of a fixed-size;

FIG. 3 depicts the exchange between an input buffer and a packet buffer, for the first cell (fragment) of a packet that arrives via the transport layer;

FIG. 4A depicts the exchange between the input buffer and the packet buffer, upon reception of the second and subsequent fragments of the packet;

FIG. 4B depicts the manner in which the EOF portion of a second (or subsequent) fragment is concatenated to the end of the fragment it belongs to;

FIG. 5 is a flow-chart that further describes the process of initial fragment handling for the second and subsequent fragments, as illustrated in FIG. 4; and

FIG. 6 is a flow-chart illustrating the processing of fragment handling for arbitrary fragments of a packet.

### DESCRIPTION OF THE PREFERRED EMBODIMENTS

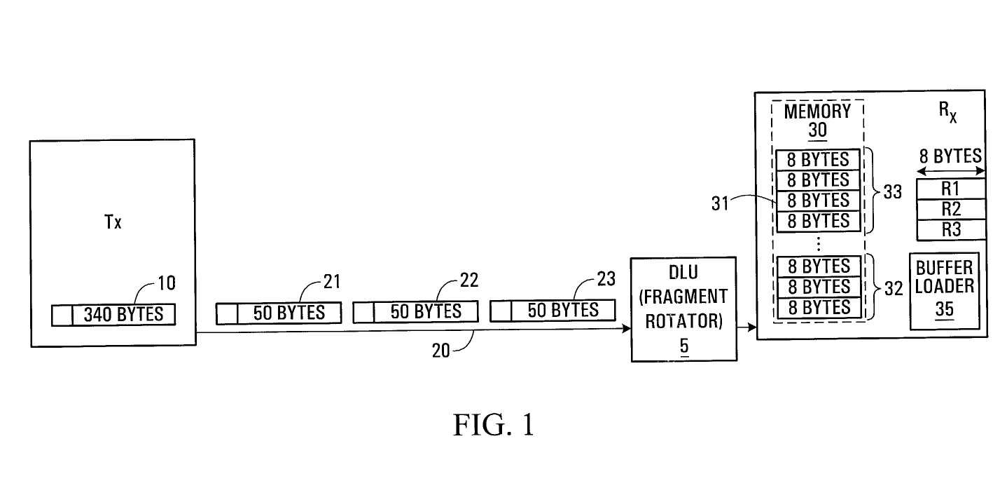

FIG. 1 is a simplified schematic diagram of a system where packet data must be passed between two computational units via a transport layer that employs fixed-size cells as a part of its operation. A computational unit Tₓ generates information or is passed information in a variable-length packet 10. A packet 10 will be required to be passed to a computational unit Rₓ, via a data transport layer 20 that connects multiple computational units (not shown) within the system. A digital logic unit (DLU) 5 constructed to function according to the invention is interposed between the data transport layer 20 and the computational unit Rₓ.

Typically the DLU 5 is colocated with and integrated with the computational unit Rₓ but this is not necessarily the case. In another embodiment, the DLU is colocated with and integral with computational unit Tₓ. The DLU may be implemented as hardware (DSP, ASIC, FPGA etc.) or software, firmware or any suitable combination of hardware, software or firmware. The DLU more generally may be referred to as a “fragment rotator” since it performs fragment rotation described below and may or may not perform transport layer functions.

Only two computational units are shown in FIG. 1 so that the discussion may be simplified; however, someone skilled in the art would understand that the invention obviously applies to a system using more than two (typically much greater than two) computational units which systems are of course common. Furthermore, it would also be obvious that the invention would provide greater benefits in systems where more than two computational units are present. The computational units may be transmitters and receivers connected by a transmission medium, for example, and this is the assumption in what follows but this is not necessarily always the case.

The transport layer 20 is confined to transporting fixed-size cells that are typically, but not always, smaller than a variable-length packet. In FIG. 1, as per the example presented, the payload size of those cells (e.g. 21, 22, and 23) is 50 bytes, while the payload of the packet has a length of 340 bytes.

The computational unit Rₓ includes a memory 30 that is comprised of a plurality of fixed size memory locations 31. In this example, the addressability of the memory 30 being to the resolution of the fixed size memory locations, the size of a memory location 31 is 8 bytes. An input buffer 32 and a packet buffer 33 are allocated (dynamically or statically) within the memory 30. The input buffer 32 is typically allocated so that it is large enough to store the contents of one fixed-size cell, thus it comprises typically a first plurality of the memory locations 31 within the memory 30. The packet buffer 33 comprises a second plurality of the memory locations 31 within the memory 30. The packet buffer 33 is allocated large enough to store a variable-length packet 10. As the allocation can be dynamic it can be done upon reception of the first cell of a packet 10, but after processing the header of that cell.

It is typical that the size of a memory location 31 is smaller than that of a transport layer cell, both of which are typically smaller than a packet 10. Yet, the invention is not restricted to this circumstance and the method disclosed would apply to any sizes specified for the packets (which are typically of variable length), transport cells and memory locations.

The computational unit Rₓ also includes a number of registers R1, R2, R3 for use in manipulating data to be written to the memory 30. These are discussed in detail below. It is noted that more generally any suitable memory elements may be used to achieve the function of the registers.

The computational unit Rₓ also has a buffer loader 35 which transfers data from the input buffer 32 to the packet buffer 33 as detailed below. This may be implemented in hardware, firmware or software or any combination thereof.

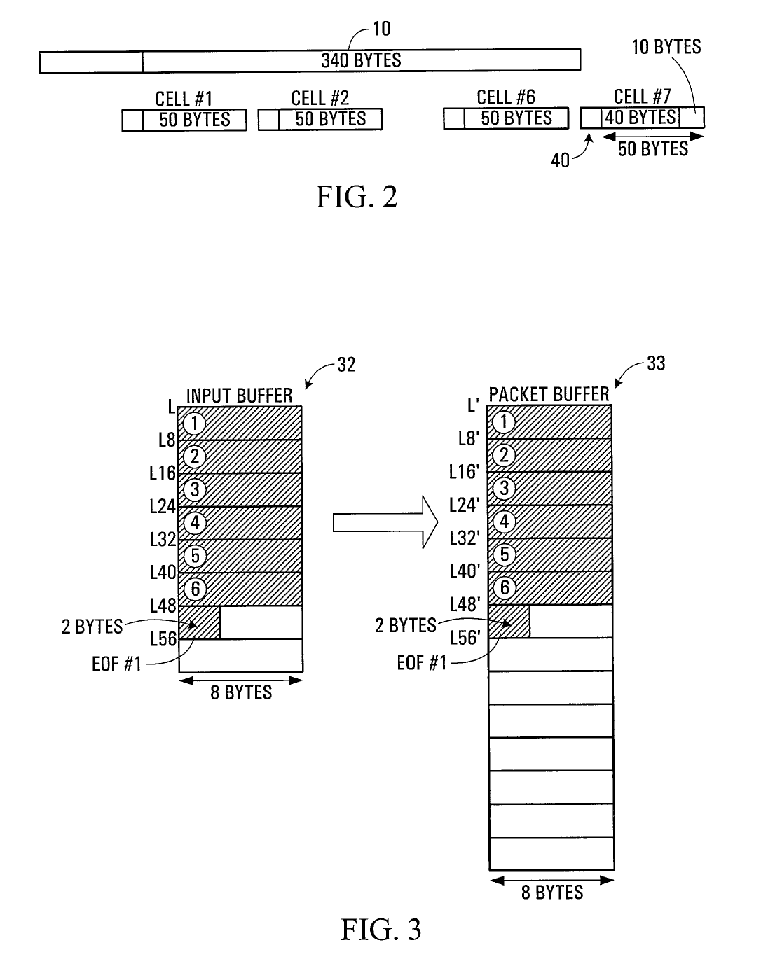

FIG. 2 illustrates the fragmentation of a large, variable-length packet into cells of a fixed-size, wherein the packet length is not evenly divisible by the cell size, as per the example started in FIG. 1. The packet 10, previously introduced, within Tₓ in FIG. 1 is to be passed to Rₓ and as such must be separated into fragments and placed into 50 byte (fixed-size) cells. Herein, this process will be referred to as fragmentation of a packet. The packet 10 has a payload length of 340 bytes. Thus seven cells must be used to transport the packet 10 through a transport layer 20. However, 340 is not evenly divisible by 50 so the last cell must contain 10 bytes of padding. The padding is meaningless data, typically all zeros or 256s (i.e. all one eight-bit binary words). The amount of padding is present in a header 40 of a cell 7 or derived, by a receiver Rₓ, based on information known about the packet 10. A sequence number is assigned to each fragment. It is assumed for the example that the sequence numbers for the fragments start at zero for the first fragment and increase by one for each subsequent fragment.

FIG. 3 depicts the exchange between an input buffer 32 and a packet buffer 33 coordinated by the buffer loader 35. From now on only the contents of the cells, being the fragments of the packet, will be referred to as being received within an input buffer 32 of Rₓ. In the illustrated example, the input buffer 32 has memory locations L0, L8, L16, and so on to L56. In other words the memory addresses start at zero and are multiples of 8 each location holding 8 bytes. Likewise, the packet buffer 33 is addressed in the same manner but the last address is not limited to L56. This addressing scheme is only one example of an addressing scheme that can be used. Other addressing schemes within for the memory 30 could be used without departing from the spirit of the present invention. It is also noted that the invention is not limited to performing manipulation at the byte resolution. More generally any symbol resolution may be employed.

After the reception of the first fragment into the input buffer 32, the fragment can be moved directly into the packet buffer 33 starting at location L0′, as per this example. The example of FIG. 3 shows a 50 byte fragment in the input buffer 32 and then shows the packet buffer 33 after transfer of the fragment. As introduced earlier, the problem of unaligned memory accesses begins once subsequent fragments must be adjoined, within the packet buffer, to the exact end of the first fragment. Memory location L56, contains the last two bytes of the first fragment.

The addition of SOF data from the following fragment to the memory location 56 is referred to as an unaligned memory address. The method disclosed herein ensures that this is the only unaligned memory access that must occur within the packet buffer 33 for this fragment, and that the problem is not transferred to the input buffer 32.

The DLU 5, receives the cells from the transport layer before they are passed to the computational unit Rₓ. The DLU 5 rotates the internal sequence of symbols within the fragments other than the first fragment such that, for the second and subsequent fragments of a packet 10, a precise number of bytes from the end of the fragment (EOF) are moved to the front of the fragment (SOF).

The precise number of bytes from the EOF which are moved to the front of the fragment is the number of bytes, within the last memory address for the previous fragment, that was written to within the packet buffer 33 that do contain meaningful data. This number can be determined as a function of the size of a memory location 31, the size of a cell and an indication of the fragment position within the packet (the sequence number). In the example of FIG. 3, the first fragment has two bytes in memory location 24′ so the next fragment is rotated by two bytes.

In general, the number of bytes an arbitrary fragment is rotated is equal to a remainder obtained once a fragment's sequence number is multiplied by the size (in terms of the number of symbols) of a fixed-size transport cell and then divided by the size (in terms of number of symbols) of a single memory location. For any arbitrary fragment, of a packet 10, the remainder may be zero, while the remainders for other fragments may not be. In such an instance the fragment is obviously not rotated as all of the memory accesses for this fragment, both from the input buffer 32 and into the packet buffer 33, are aligned.

The mathematical relation expressing the number of symbols (in our example symbols are bytes) an arbitrary fragment is rotated is given below:

Symbol_rotation=(SN*CS)mod(MUS)

where SN is the sequence number for the fragment, CS is the size of the fixed-size cell, in terms of symbols, and MUS is the size of a single memory location in the receiver Rₓ, also in terms of symbols. To those skilled in the art (X)mod(Y) is known to be the remainder given after dividing X by Y.

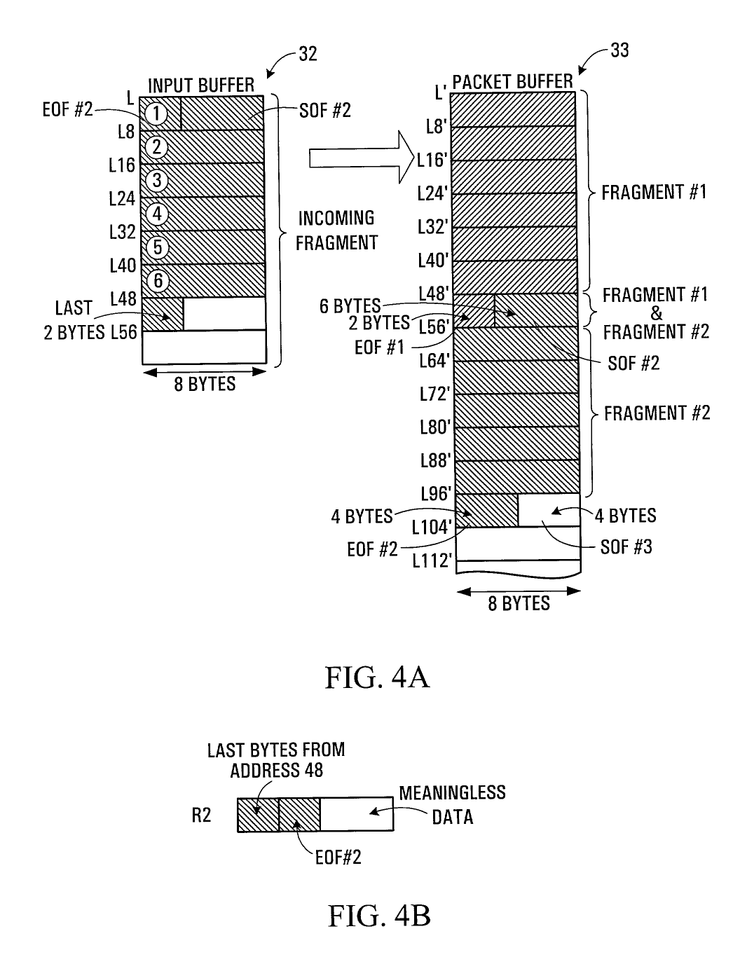

The DLU 5 performs the rotation within a fragment and sends the fragment thus rotated to the input buffer 32 of the computational unit Rₓ. An example is shown in FIG. 4A. The input buffer then contains the second fragment (or subsequent fragment) that has been operated upon by DLU 5, the DLU having rotated the second (or subsequent) fragment to place the required number of EOF bytes of the fragment at the beginning of the fragment. Thus, within the first memory locations within the input buffer 32, the first two bytes are the EOF bytes labelled EOF #2 and the remaining six bytes are the SOF bytes labelled SOF #2, as shown in FIG. 4A. The remaining memory locations, within the input buffer 32, contain the rest of the second (or subsequent) fragment.

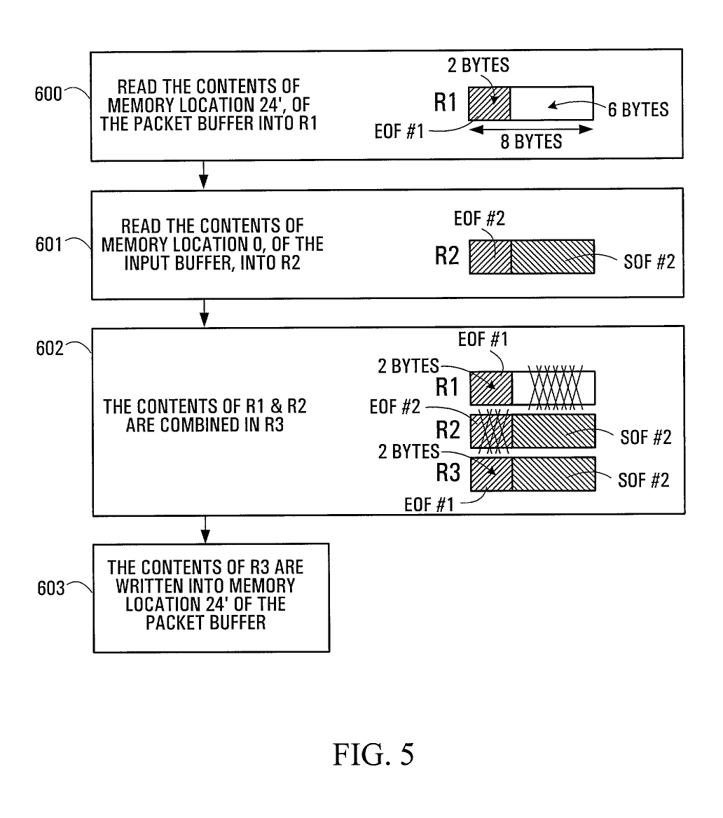

Now a single unaligned memory access, for this fragment, can be performed at a memory location 31 addressed by offset L48′ within the packet buffer 33, to adjoin the second fragment to the end of the first (previous), as indicated in the flow-chart comprised of steps 600 to 603 of FIG. 5 by operating on registers R1, R2, R3. To do so: 1) At step 600 the contents of address L48′, within the packet buffer 33, are read into register R1 within the computational unit Rₓ; 2) At step 601, carried out sequentially or in parallel to 600, the contents of the first memory location, within the input buffer 32, are read into register R2; 3) At step 602, the contents of registers R1 and R2 are combined in register R3; 4) Finally, at step 603, the contents of register R3 are written into the memory location 31 addressed by address L48′ within the packet buffer 33.

To elaborate on what was stated above in step 3): The contents of the registers R1 and R2 are combined such that the EOF of the previous fragment now present in R1 is combined with the SOF of the new fragment present in R2. The EOF portion of the new fragment present in R2 is preserved in that register to be concatenated to the end of the new fragment. To enable this operation the contents of the register R2 must be shifted to the right and combined with the meaningful contents of the last memory location in input buffer 32 containing the fragment. FIG. 4B illustrates this last step in which the contents of the register R2 (the EOF #2 data) is shifted to the right (or more generally by the number of bytes in the last memory location of the input buffer 32 for the fragment) and the bytes of the last memory location within the input buffer 32 addressed containing meaningful data are placed in front of the EOF #2 data. The contents of R2 can then be stored in the next available memory location within the packet buffer 33. In this example that offset is L96′, as shown in FIG. 4A. This operation does not qualify as an unaligned memory access as the EOF of the second fragment is already in a register and the last portion of the new fragment resides in an aligned memory location within the input buffer 32. The third and subsequent fragments are handled in a similar manner.

Register R3 in the above operation can be replaced with register R1 as long as the EOF bytes of the previous fragment (in this instance that would be the first fragment of a packet 10) are preserved when adding (masking in) to register R1 the SOF bytes of the most recent fragment (in this instance that would be the second fragment of a packet 10).

Once the single unaligned memory access occurs for a fragment, the remainder of that fragment, which now begins at an addressable memory location 31, addressed by address L8, within the input buffer 32 can be moved into an available addressable memory location 31. In other words, the transfer of the remainder of the fragment will occur using only aligned memory accesses. This will occur until the fragment has been completely moved to from the input buffer 32 to the packet buffer 33, at which time the next fragment, of packet 10, will overwrite the contents of an input buffer 32. The EOF for the second (or subsequent) fragment is detailed in the general fragment handling case described below.

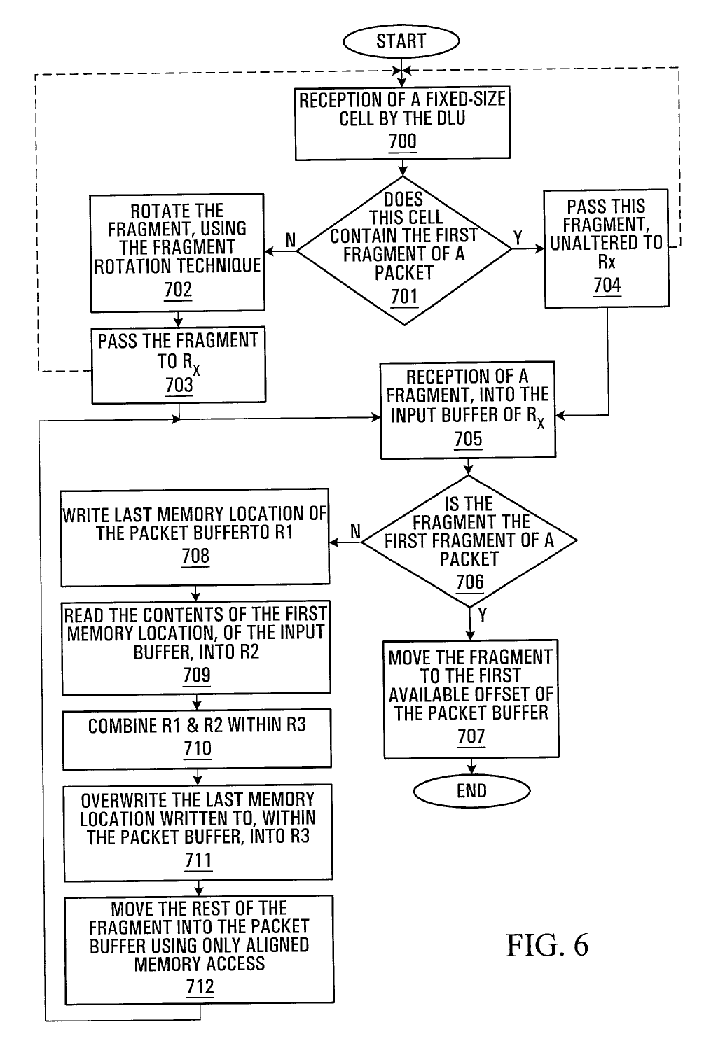

FIG. 6 is a flow-chart depicting the process receiving fixed-size cells from the transport layer, and storing them in the packet buffer 33.

At step 700, the DLU 5 receives a fixed-sized cell from the transport layer, from which the DLU 5 determines, at step 701, if the cell is carrying the first fragment of a packet. If it is (i.e. YES), at step 704 the fragment is passed to a computational unit Rₓ, thereby the computational unit Rₓ receives the fragment into its input buffer, as indicated by step 705. If the cell does not contain the first fragment of a packet, during step 702 the fragment is rotated using the technique described above. Then at 703 the fragment is passed from the DLU to computational unit Rₓ. The computational unit Rₓ receives the fragment into its input buffer, as indicated by step 705. At both 703 and 704, the state of the DLU 5 returns to state 700 where it can receive the subsequent fragment to be processed. However, the subsequent fragments are not passed to computational unit Rₓ until computational unit Rₓ has moved the previous fragment from the input buffer to the packet buffer.

At step 705 computational Rₓ receives the fragment into its input buffer; thereafter, during step 706, computational unit R^{x} determines if the fragment is the first fragment of a packet. It does so either from information from the transport layer, always available to it, or an indication from the DLU, such as a flag. If the fragment is the first fragment of a packet, the fragment is moved directly into the first available addressable memory location of the packet buffer as indicated in step 707. However, if it is not the first fragment of the sequence computational unit Rₓ proceeds through steps 708 to 711 (inclusive) to perform a single unaligned memory access to adjoin the beginning of this fragment to the end of the previous fragment. Steps 708 to 711 (inclusive) are the same as steps 600 to 603 (inclusive), shown in FIG. 5.

Finally at step 712 the remainder of the fragment in the input buffer is moved from the input buffer to the packet buffer. Note that the last memory location of the packet buffer written to will contain the contents of the last memory location in the input buffer combined with the EOF data as described with reference to FIG. 4B. Due to the application of the packet-fragment reassembly method in which the second and subsequent packets are rotated by a precise number of symbols, on the second and subsequent accesses, the memory accesses are all aligned, in that: all read operations, from the input buffer, happen at regular addressable memory locations within the input buffer; and, all write operation to the packet buffer, happen at regular addressable memory locations, within the packet buffer. Then, from step 712 the state of the computational unit Rₓ, with respect to receiving fragments, returns to step 705 so that it can receive a new fragment to be reassembled in the packet buffer.

In the above described embodiment, the EOF data is moved to the beginning of the fragment. This allows the fragment thus rotated to be transmitted with no change in the transmission capacity, but does require the reconstruction of the end of the cell as detailed with respect to FIG. 4B. In another embodiment, if transmission resources are not a priority, or if the method is only to be implemented at a receiver, rather than inserting the EOF bytes at the start of the fragment, the whole fragment can be shifted to the right by the same number of bytes, padding the first memory location. This avoids the need to reconstruct the last memory locations.

While preferred embodiments of the invention have been described and illustrated, it will be apparent to one skilled in the art that numerous modifications, variations and adaptations may be made without departing from the scope of the invention as defined in the claims appended hereto.

We claim:

1. A method of processing fragments of a data packet comprising, for second and subsequent fragments of the data packet, rotating an EOF (end of fragment) portion of a payload of each fragment to before a SOF (start of fragment) portion of the payload of the fragment, the size of the EOF portion being equal to a size of a terminating portion of a respective preceding fragment.

2. A method according to claim 1 wherein the size of the EOF portion is a function of a sequence number of the fragment, the fragment size and the size of a smallest addressable memory unit.

3. A method according to claim 1 wherein the size of the EOF portion rotated expressed in symbols is given by
Symbol_rotation=(SN*CS)mod(MUS)
where SN is a sequence number for the fragment, CS is a size of a fixed-size cell used to carry the fragment, in terms of symbols, and MUS is a size of a single memory location in a memory to which the fragments are to be transferred, also in terms of symbols.

4. A method according to claim 1 further comprising:
transmitting the fragments after rotation.

5. A method according to claim 1 further comprising:
receiving the fragments prior to rotation.

6. A method according to claim 1 further comprising:
transferring the first fragment and each other fragment thus rotated in sequence to an input buffer;
after any fragment is transferred to the input buffer, transferring the fragment to a packet buffer with no unaligned memory accesses for the first fragment, and a maximum of one unaligned memory access for each other fragment.

7. A method according to claim 6 wherein after a fragment is transferred to the input buffer, the fragment is stored in the input buffer in a first memory location, a plurality of intermediate memory locations and a last memory location, and wherein transferring each fragment to the packet buffer comprises:
for the first fragment, transferring the entire fragment to the packet buffer including a last portion of the fragment in a last written-to memory location in the packet buffer, the last portion being the terminating portion for the first fragment;
for second and subsequent fragments:
a) in an unaligned memory access, combining the portion of the preceding fragment in the last written-to memory location for the preceding fragment in the packet buffer with data from the first memory location and writing it to the last written-to memory location for the preceding fragment;
b) writing intermediate memory locations from the input buffer to the packet buffer using aligned memory accesses;
c) combining contents of the last memory location in the input buffer with the EOF portion for the fragment and writing to a last written-to memory location in the packet buffer for the fragment, the combination of the last memory location with the EOF portion for the fragment being the terminating portion for the fragment.

8. An apparatus for use in reassembling fragments of a data packet in memory having a smallest addressable memory unit, the apparatus comprising means for rotating an EOF (end of fragment) portion of a payload of each fragment to before an SOF (start of fragment) portion of the payload of the fragment and means for determining the size of each EOF portion as a function of the sequence number of the fragment, the fragment size and the size of the smallest addressable unit.

9. An apparatus comprising:
a packet rotator adapted to process fragments of a data packet comprising, for second and subsequent fragments of the data packet, by rotating an EOF (end of fragment) portion of a payload of each fragment to before a SOF (start of fragment) portion of the payload of the fragment, the size of the EOF portion being equal to a size of a terminating portion of a respective preceding fragment.

10. An apparatus according to claim 9 further comprising:
an input buffer;
a packet buffer having a smallest addressable memory unit;
the fragment rotator being adapted to transfer the first fragment and each other fragment thus rotated in sequence to the input buffer;
a buffer loader adapted to transfer contents of the input buffer to the packet buffer, by after any fragment is transferred to the input buffer, transferring the fragment to the packet buffer with no unaligned memory accesses for the first fragment, and a maximum of one unaligned memory access for each other fragment.

11. An apparatus according to claim 10 wherein the size of the EOF portion is a function of a sequence number of the fragment, the fragment size and the size of the smallest addressable memory unit.

12. An apparatus according to claim 11 wherein the size of the EOF portion rotated expressed in symbols is given by
Symbol_rotation=(SN*CS)mod(MUS)
where SN is a sequence number for the fragment, CS is a size of a fixed-size cell used to carry the fragment, in terms of symbols, and MUS is the size of the smallest addressable memory unit.

13. An apparatus according to claim 10 adapted to transmit the fragments after rotation.

14. An apparatus according to claim 10 further adapted to receive the fragments prior to rotation.

15. An apparatus according to claim 10 wherein after a fragment is transferred to the input buffer, the fragment is stored in the input buffer in a first memory location, a plurality of intermediate memory locations and a last memory location, and the buffer loader transfers each fragment to the packet buffer by:
for the first fragment, transferring the entire fragment to the packet buffer including a last portion of the fragment in a last written-to memory location in the packet buffer, the last portion being the terminating portion for the first fragment;
for second and subsequent fragments:
a) in an unaligned memory access, combining the portion of the preceding fragment in the last written-to memory location for the preceding fragment in the packet buffer with data from the first memory location and writing it to the last written-to memory location for the preceding fragment;
b) writing intermediate memory locations from the input buffer to the packet buffer using aligned memory accesses;
c) combining contents of the last memory location in the input buffer with the EOF portion for the fragment and writing to a last written-to memory location in the packet buffer for the fragment, the combination of the last memory location with the EOF portion for the fragment being the terminating portion for the fragment.

16. A method of processing fragments of a data packet comprising, for second and subsequent fragments of the data packet, shifting each fragment by an amount equal to a size of a terminating portion of a respective preceding fragment, the size of the shift being a function of a sequence number of the fragment, the fragment size and the size of a smallest addressable memory unit;
transferring the first fragment and each other fragment thus shifted in sequence to an input buffer;
after any fragment is transferred to the input buffer, transferring the fragment to a packet buffer with no unaligned memory accesses for the first fragment, and a maximum of one unaligned memory access for each other fragment.

17. A method according to claim 16 wherein after a fragment is transferred to the input buffer, the fragment is stored in the input buffer in a first memory location, a plurality of intermediate memory locations and a last memory location, and wherein transferring each fragment to the packet buffer comprises:
for the first fragment, transferring the entire fragment to the packet buffer including a last portion of the fragment in a last written-to memory location in the packet buffer, the last portion being the terminating portion for the first fragment;
for second and subsequent fragments:
a) in a unaligned memory access, combining the portion of the preceding fragment in the last written-to memory location for the preceding fragment in the packet buffer with data from the first memory location and writing it to the last written-to memory location for the preceding fragment;
b) writing intermediate memory locations from the input buffer to the packet buffer using aligned memory accesses;
c) writing contents of the last memory location in the input buffer to a last written-to memory location in the packet buffer for the fragment
